(19) United States
(12) Patent Application Publication
(10) Pub. No.: US 2009/0056483 A1
(43) Pub. Date: Mar. 5, 2009

(54) Sliding Rail Structure for Use in Cuckoo Clocks

(76) Inventor: Chzng-Tzen Tsai, Erlin Township (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/848,508

(22) Filed: Aug. 31, 2007

(51) Int. Cl. F16H 19/04; G04B 25/06

(52) U.S. Cl. 74/29

(57) ABSTRACT

A sliding rail structure for use in cuckoo clocks comprises a base including a guiding member provided thereon and having an elongated sliding piece correspondingly fixed thereon, the sliding piece including a rack mounted on one side thereof, and including an engaging recess formed on the front end thereof for inserting a stem of a cuckoo element, characterized in a casing and a housing are fixed onto the base for pressing against the two sides of the sliding piece, respectively, thus obtaining a stable reciprocating movement of the sliding piece, and the guiding member further includes an elongated slot formed at the center thereof, a peg is extendedly arranged on the bottom of the sliding piece for being fitted into the guide slot of the guiding member, and for screwing a confining element therein, thereby preventing the disengagement of said sliding piece for causing a stopping effect.

### BACKGROUND OF THE INVENTION

1. Field of the Invention

The present invention relates to a sliding rail structure, and more particularly to a sliding rail structure for use in cuckoo clocks that may prevent the disengagement of the sliding piece for causing a stable reciprocating movement.

2. Description of the Prior Arts

Generally, a clock is provided to tell time in a variety of different manners. For example, a prior art clock tells time at the right clock by making sounds, nevertheless, such a time telling way is extremely dull. To overcome this problem, a cuckoo clock has been developed, wherein a cuckoo element is urged to extend outward from the interior of the clock for telling time at the right clock.

Referring to FIGS. 1 and 2, a prior art sliding rail structure for use in cuckoo clocks comprises a base 10 including a guiding slot 101 provided thereon and having an elongated sliding piece 20 correspondingly fixed thereon, the sliding piece 20 including a rack 201 mounted on one side thereof for relatively engaging with a pinion gear (not shown) which is attached on the bottom of a double gear 102 in the base 10. The double gear 102 includes a gear secured on the top surface thereof for engaging with a worm 104 of a shaft of a motor 103, and the sliding piece 20 further includes an engaging recess 202 formed on the front end thereof for inserting a stem 301 of a cuckoo element 30. The guiding slot 101 includes a stepped positioning projection 105 disposed adjacent to one side thereof for pressing against the sliding piece 20, thereby achieving a smooth reciprocating movement of the sliding piece 20. Furthermore, a covering member 40 is covered onto the base 10.

However, the sliding piece 20 of the prior art sliding rail structure for use in cuckoo clocks can not be securely pressed by the positioning projection 105 and the double gear 102, occurring a disengagement or an unstable movement.

The present invention has arisen to mitigate and/or obviate the afore-described disadvantages.

### SUMMARY OF THE INVENTION

The primary object of the present invention is to provide a sliding rail structure for use in cuckoo clocks that may prevent the disengagement of the sliding piece for causing a stable reciprocating movement.

In accordance with one aspect of the present invention, there is provided a sliding rail structure for use in cuckoo clocks comprising a base, an elongated sliding piece, a cuckoo element, a casing, a housing, a confining element, and a covering member, wherein the base includes a guiding member provided thereon and having an elongated slot formed at the center thereof, and includes a double gear disposed on one side of the guiding member. The double gear is comprised of an upper gear and a lower gear, and the upper gear is engaged with a pulley by using a spur gear, the pulley is coupled to a shaft of a motor by way of a belt. The elongated sliding piece includes a rack mounted on one side thereof, and includes an engaging recess formed on the top surface of the front end thereof, includes a peg fixed on the bottom surface of the rear end thereof and having a hole formed therein. The cuckoo element includes a stem affixed on the bottom thereof, and the casing includes a top panel arranged thereon, and includes a side panel secured on the right side of the top panel and extending downwardly. The housing includes a top plate arranged thereon, and includes a side plate secured on the left side of the top plate, extending downwardly, and having a notch attached thereon. Besides, the confining element is a screw for generating a stopping effect.

In assembly, the stem of the cuckoo element is inserted in the engaging recess of the sliding piece, and the sliding piece is slidably affixed onto the guiding member of the base so that the rack of the sliding piece engages with the lower gear of the double gear and the peg retains in the guide slot of the guiding member. The casing and the housing are fixed onto the base for covering the two sides of the guiding member by using screws, respectively, such that the double gear extends out of the notch of the housing, and the top panel of the casing and the top plate of the housing press against the two sides of the sliding piece for a stable reciprocating movement, and the confining element is screwed into the hole of the peg for a stopping purpose. Finally, the covering member is affixed on the base by means of screws, finishing the assembly.

The present invention will become more obvious from the following description when taken in connection with the accompanying drawings, which show, for purpose of illustrations only, the preferred embodiment in accordance with the present invention.

### BRIEF DESCRIPTION OF THE DRAWINGS

FIG. 1 is a perspective diagram illustrating the exploded components of a prior art sliding rail structure for use in cuckoo clocks;

FIG. 2 is a cross sectional diagram illustrating the assembly of the prior art sliding rail structure for use in cuckoo clocks;

FIG. 3 is a perspective diagram illustrating the exploded components of a sliding rail structure for use in cuckoo clocks according to the present invention;

FIG. 4 is a perspective diagram illustrating the assembly of the sliding rail structure for use in cuckoo clocks according to the present invention;

FIG. 5 is a cross sectional diagram illustrating the assembly of the sliding rail structure for use in cuckoo clocks according to the present invention;

FIG. 6 is a top plan diagram illustrating the operation of the sliding rail structure for use in cuckoo clocks according to the present invention;

FIG. 7 is another top plan diagram illustrating the operation of the sliding rail structure for use in cuckoo clocks according to the present invention.

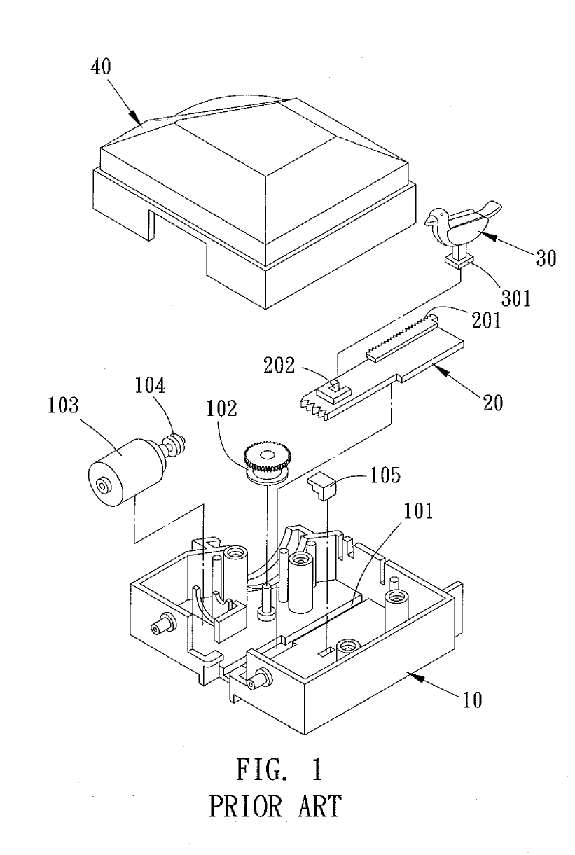

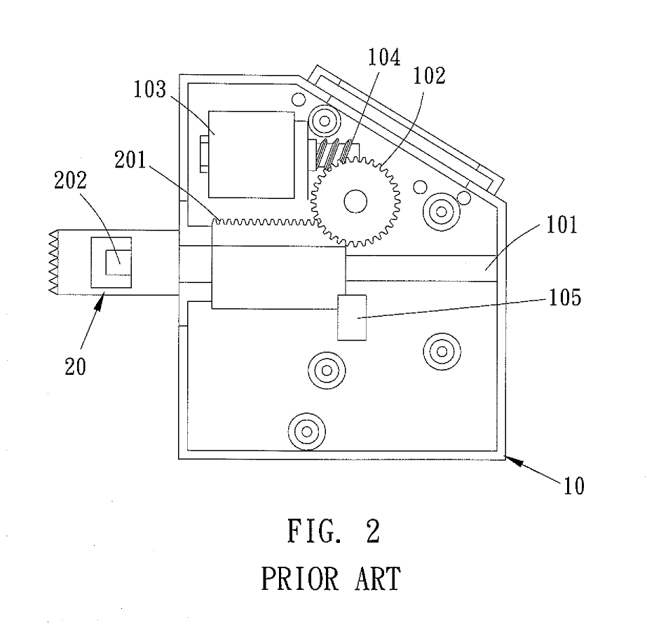

### DETAILED DESCRIPTION OF THE PREFERRED EMBODIMENT

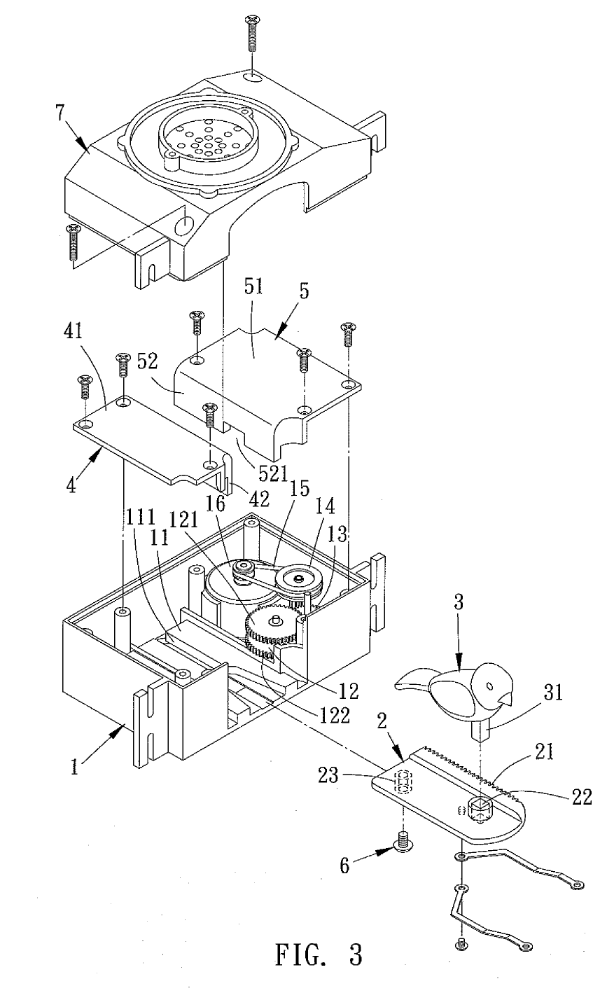

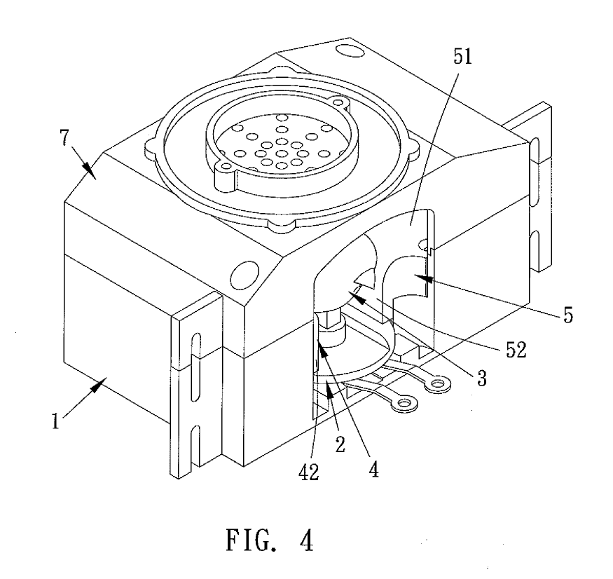

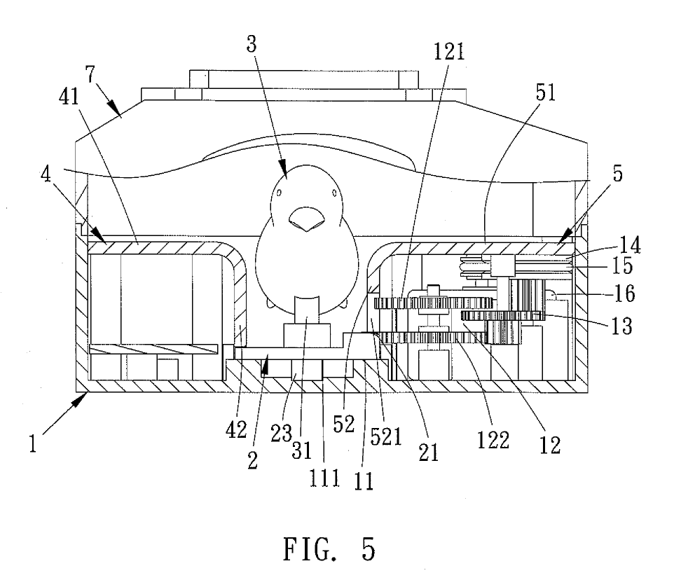

Referring to FIGS. 3-5, a sliding rail structure for use in cuckoo clocks in accordance with the present invention comprises a base 1, an elongated sliding piece 2, a cuckoo element 3, a casing 4, a housing 5, a confining element 6, and a covering member 7, wherein the base 1 includes a guiding member 11 provided thereon and having an elongated slot 111 formed at the center thereof, and includes a double gear 12 disposed on one side of the guiding member 11. The double gear 12 is comprised of an upper gear 121 and a lower gear 122, and the upper gear 121 is engaged with a pulley 14 by using a spur gear 13, the pulley 14 is coupled to a shaft of a motor 16 by way of a belt 15. The elongated sliding piece 2 includes a rack 21 mounted on one side thereof, and includes an engaging recess 22 formed on the top surface of the front end thereof, and includes a peg 23 fixed on the bottom surface of the rear end thereof and having a hole formed therein. The cuckoo element 3 includes a stem 31 affixed on the bottom thereof, and the casing 4 includes a top panel 41 arranged thereon, and includes a side panel 42 secured on the right side of the top panel 41 and extending downwardly. The housing 5 includes a top plate 51 arranged thereon, and includes a side plate 52 secured on the left side of the top plate 51, extending downwardly, and having a notch 521 attached thereon. Besides, the confining element 6 is a screw for generating a stopping effect.

In assembly, the stem 31 of the cuckoo element 3 is inserted in the engaging recess 22 of the sliding piece 2, and the sliding piece 2 is slidably affixed onto the guiding member 11 of the base 1 so that the rack 21 of the sliding piece 2 engages with the lower gear 122 of the double gear 12 and the peg 23 retains in the guide slot 111 of the guiding member 11. The casing 4 and the housing 5 are fixed onto the base 1 for covering the two sides of the guiding member 11 by using screws, respectively, such that the double gear 12 extends out of the notch 521 of the housing 5, and the top panel 41 of the casing 4 and the top plate 51 of the housing 5 press against the two sides of the sliding piece 2 for a stable reciprocating movement, and the confining element 6 is screwed into the hole of the peg 23 for a stopping purpose. Finally, the covering member 7 is affixed on the base 1 by means of screws, finishing the assembly.

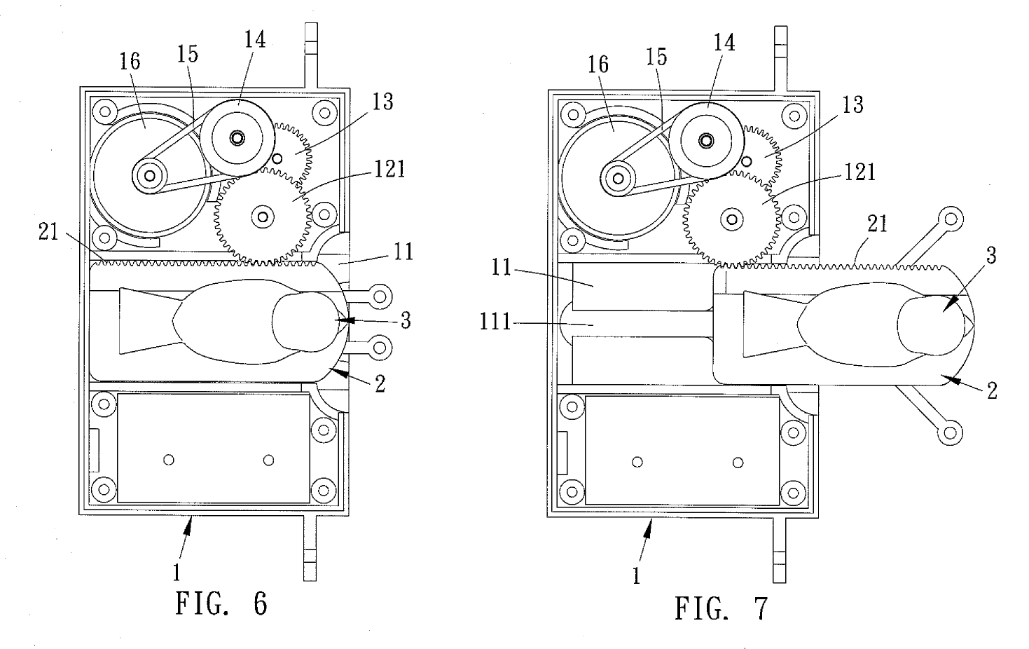

While at the time telling moment, as shown in FIGS. 6-7, the motor 16 is controlled by the driving signal to urge the double gear 12 through the belt 15, the pulley 14, and the spur gear 13 such that the sliding piece 2 moves forward to have the time telling process, thereafter, the motor 16 rotates conversely to drive the double gear 12 through the belt 15, the pulley 14, and the spur gear 13 so as to actuate the sliding piece 2 to return back to its original position. It is to be noted that since the casing 4 and the housing 5 press against the sliding piece 2, and the confining element 6 is used for a stopping effect, resulting in a stable reciprocating movement of the sliding piece 2.

It can be clearly seen from the preceding accounts on the features of the present invention that the sliding rail structure for use in cuckoo clocks of the present invention has the following advantages:

Due to the casing 4 and the housing 5 are fixed onto the base 1 for covering the two sides of the guiding member 11 by using screws, respectively, and the peg 23 is extendedly arranged on the bottom of the sliding piece 2 for being fitted into the guide slot 111 of the guiding member 11, and for screwing a confining element 6 therein, thereby preventing the disengagement of the sliding piece 2 for causing a stable reciprocating movement.

The invention is not limited to the above embodiment but various modifications thereof may be made. It will be understood by those skilled in the art that various changes in form and detail may made without departing from the scope and spirit of the present invention.

What is claimed is:

1. A sliding rail structure for use in cuckoo clocks comprising:
a base including a guiding member provided thereon and having an elongated sliding piece correspondingly fixed thereon, said sliding piece including a rack mounted on one side thereof for engaging with a lower gear of a double gear, and an upper gear of said double gear being engaged with a pulley by using a spur gear, said pulley being coupled to a shaft of a motor by way of a belt, and said sliding piece further including an engaging recess formed on the top surface of the front end thereof for inserting a stem of a cuckoo element, characterized in:
a casing and a housing are fixed onto said base for pressing against the two sides of said sliding piece, respectively, thus obtaining a stable reciprocating movement of said sliding piece, and said guiding member further includes an elongated slot formed at the center thereof a peg is extendedly arranged on the bottom of said sliding piece for being fitted into said guide slot of said guiding member, and for screwing a confining element therein, thereby preventing the disengagement of said sliding piece for causing a stopping effect.

2. The sliding rail structure for use in cuckoo clocks as claimed in claim 1, wherein said casing includes a top panel arranged thereon, and includes a side panel secured on the right side of said top panel and extending downwardly.

3. The sliding rail structure for use in cuckoo clocks as claimed in claim 1, wherein said housing includes a top plate arranged thereon, and includes a side plate secured on the left side of said top plate, extending downwardly, and having a notch attached thereon.

4. The sliding rail structure for use in cuckoo clocks as claimed in claim 1, wherein said sliding piece includes a peg fixed on the bottom surface of the rear end thereof.

5. The sliding rail structure for use in cuckoo clocks as claimed in claim 1, wherein said peg of said sliding piece includes a hole formed therein.

6. The sliding rail structure for use in cuckoo clocks as claimed in claim 1, wherein said confining element is a screw for generating a stopping effect.
